(19) United States
(12) Patent Application Publication
(10) Pub. No.: US 2024/0263448 A1
(43) Pub. Date: Aug. 8, 2024

(54) PREFABRICATED WALL AND METHOD OF FORMING THEREOF

(71) Applicant: Green Canopy NODE Technologies, Inc., Seattle, WA (US)

(72) Inventor: Darrin Russell Griechen, Spokane, WA (US)

(21) Appl. No.: 18/432,835

(22) Filed: Feb. 5, 2024

Related U.S. Application Data
(60) Provisional application No. 63/483,445, filed on Feb. 6, 2023.

(51) Int. Cl. E04C 2/52; E04B 2/00; E04C 2/12; H02G 1/00; H02G 3/38

(52) U.S. Cl. CPC E04C 2/521; E04C 2/12; E04C 2/46; H02G 1/00; H02G 3/388

(57) ABSTRACT

A prefabricated wall includes a surface, a depressed face spaced apart from the surface, an electrical assembly cavity adjacent to the depressed face, a first electrical pathway extending from the electrical assembly cavity, and a second electrical pathway extending from an end of the first electrical pathway at an angle from between 0 and 90 degrees of the first electrical pathway.

### CROSS-REFERENCE TO RELATED APPLICATION

This application claims priority under 35 U.S.C. § 119 to U.S. Provisional Application No. 63/483,445 filed on Feb. 6, 2023, in the United States patent and Trademark Office, the disclosure of which is incorporated by reference herein in its entirety.

### BACKGROUND

The following relates generally to a prefabricated wall. A prefabricated structure (such as a prefabricated wall) can be built in a factory setting, rather than in an on-site setting. A prefabricated structure offers multiple advantages compared to a traditional stick-built structure that is built on-site of pre-cut wood elements, including quality control, reduced waste, and a reduced build time. A prefabricated structure can be built to a same code standard as a traditional structure.

### SUMMARY

A method for forming a prefabricated wall is described. One or more aspects of the method include removing a first portion of a panel to form a depressed face; removing a second portion of the panel to form an electrical assembly cavity adjacent to the depressed face; removing a third portion of the panel to form a first electrical pathway extending from the electrical assembly cavity; and removing a fourth portion of the panel to form a second electrical pathway extending from an end of the first electrical pathway at an angle from between 0 and 90 degrees of the first electrical pathway.

A method for forming a prefabricated wall is described. One or more aspects of the method include drilling, in a panel, an electrical assembly cavity at a first angle; drilling, in the panel, a first electrical pathway at a second angle different from the first angle, wherein the first electrical pathway intersects the electrical assembly cavity; and drilling, in the panel, a second electrical pathway at the first angle, wherein the second electrical pathway intersects the first electrical pathway.

A prefabricated wall is described. One or more aspects of the prefabricated wall include a surface; a depressed face spaced apart from the surface; an electrical assembly cavity adjacent to the depressed face; a first electrical pathway extending from the electrical assembly cavity; and a second electrical pathway extending from an end of the first electrical pathway at an angle from between 0 and 90 degrees of the first electrical pathway.

### BRIEF DESCRIPTION OF THE DRAWINGS

FIG. 1 shows an example of an isometric, cross-sectional view of a prefabricated wall according to aspects of the present disclosure.

FIG. 2 shows an example of a prefabricated wall and a base panel according to aspects of the present disclosure.

FIG. 3 shows an example of a prefabricated including with a faceplate according to aspects of the present disclosure.

FIG. 4 shows an example of an isometric, cross-sectional view of a prefabricated wall and a base panel according to aspects of the present disclosure.

FIG. 5 shows an example of a side view of a prefabricated wall and a base panel according to aspects of the present disclosure.

FIGS. 6 and 7 show examples of methods for forming a prefabricated wall according to aspects of the present disclosure.

### DETAILED DESCRIPTION

According to aspects of the present disclosure, a prefabricated wall is provided. In some cases, the prefabricated wall includes a depressed face spaced apart from a surface of the prefabricated wall, an electrical assembly cavity, a first electrical pathway intersecting the electrical assembly cavity, and a second electrical pathway intersecting the first electrical pathway. In some cases, an electrical assembly is installed on the depressed face and in the electrical assembly cavity. In some cases, a pre-wire assembly is installed in one or more of the electrical assembly cavity, the first electrical pathway, and the second electrical pathway.

A conventional wall is framed on-site with a bottom plate, a top plate, and studs. Subsequently, electrical wiring is run along the studs, drywall is attached to the studs, a hole is cut in the drywall, a junction box is installed in the hole, an electrical assembly is installed in the junction box, and the electrical wiring is connected to the electrical assembly. This conventional process of wall construction is time-consuming and may involve the labor of multiple tradespeople. Furthermore, maintenance or replacement of the electrical assembly and wiring can be time-consuming, and may involve removal and replacement of components of the wall.

By contrast, by providing a prefabricated wall including a depressed face, an electrical assembly cavity, a first electrical pathway intersecting the electrical assembly cavity, and a second electrical pathway intersecting the first electrical pathway, aspects of the present disclosure avoid on-site wall framing, and allow for easy and efficient installation/maintenance/repair of electrical components.

In some cases, the electrical assembly cavity serves as housing for an electrical assembly, thereby allowing an installation of a junction box to be omitted. In some cases, the second electrical pathway is provided at a shallow depth to meet code requirements and promote an ease of installation and access of electrical components. In some cases, the first pathway is provided at an angle such that wiring (such as a pre-wire assembly) can be connected to an electrical assembly which penetrates further into an interior of the prefabricated wall than the second electrical pathway.

A conventional wall may be an example of tectonic manufacturing. Tectonic manufacturing refers to a methodology for the design and assembly of individual materials of a building into a singular building structure. Tectonic manufacturing is an additive process, meaning sub-components are used to create higher-level components. For example, a stick-frame building may be considered tectonic, as smaller pieces are used to create frames, frames are used to create walls, and so on.

By contrast, in some cases, the prefabricated wall is provided using a stereotomic process. Stereotomic architecture refers to a methodology for the design and assembly of a structure using stereotomy, which refers to the removal of material to form a structure. Stereotomic architecture is a subtractive process, meaning the final structure is derived by the removal of parts or material. For example, a tunnel may be considered stereotomic due to the process of removing material from a mountain to achieve an open space in the mountain.

Mass timber manufacturing may be considered stereotomic, leading to innovative processes (such as parametric architecture) when compared to tectonic manufacturing. Parametric architecture is a building design method that uses equations or algorithms to determine a shape, a size, or an orientation of building components. Parametric architecture may fall under two primary design intents: propagation-based design and constraint-based design. Propagation-based design determines an unknown final shape of a design based on an input, while constraint-based design determines a set of input parameters to achieve final known parameters.

### Prefabricated Wall

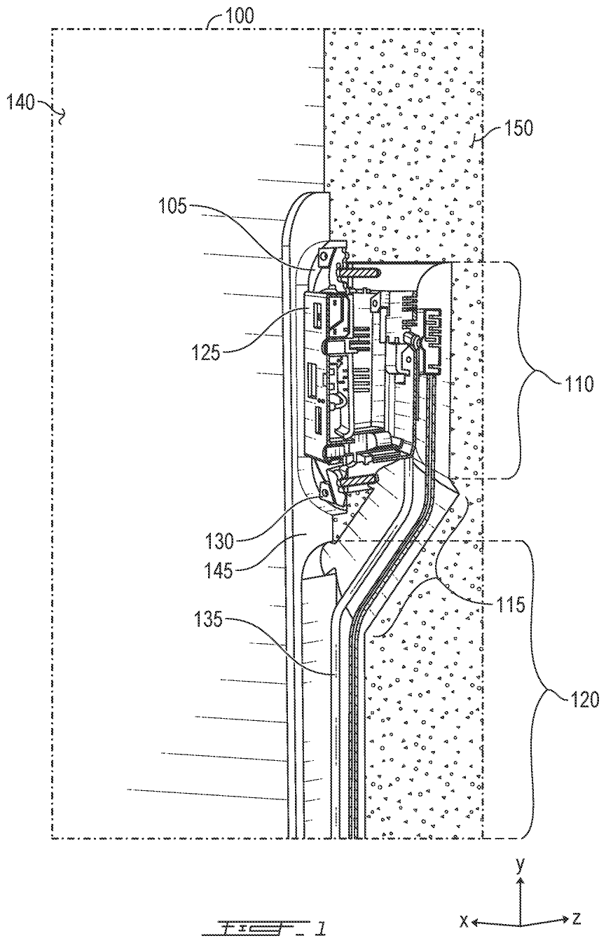

A prefabricated wall is described with reference to FIGS. 1-5. One or more aspects of the prefabricated wall include a surface; a depressed face spaced apart from the surface; an electrical assembly cavity adjacent to the depressed face; a first electrical pathway extending from the electrical assembly cavity; and a second electrical pathway extending from an end of the first electrical pathway at an angle from between 0 and 90 degrees of the first electrical pathway.

In some aspects, the first electrical pathway consists of a first end, a second end, and a remaining portion. In some aspects, the first end opens to the electrical assembly cavity. In some aspects, the second end opens to the second electrical pathway. In some aspects, the remaining portion is surrounded by an interior portion of the prefabricated wall.

FIG. 1 shows an example of an isometric, cross-sectional view of a prefabricated wall 100 according to aspects of the present disclosure. The example shown includes prefabricated wall 100, first depressed face 105, electrical assembly cavity 110, first electrical pathway 115, second electrical pathway 120, electrical assembly 125, tab 130, pre-wire assembly 135, panel surface 140, second depressed face 145, and panel interior 150.

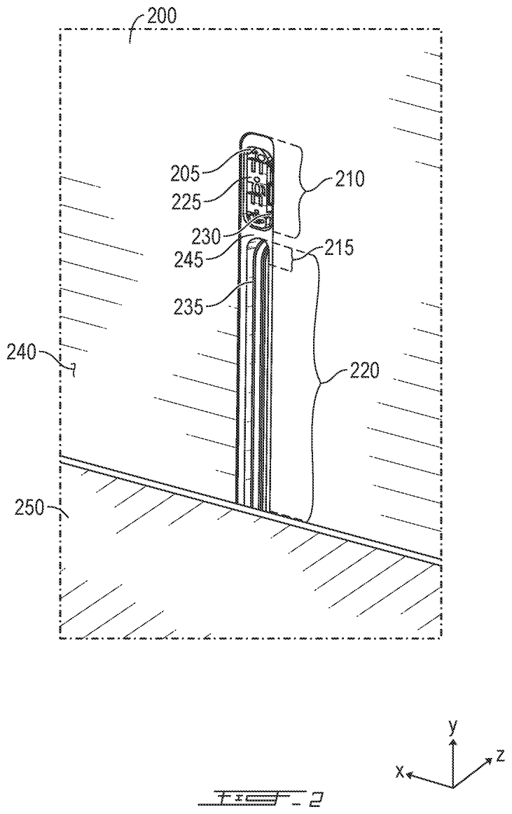

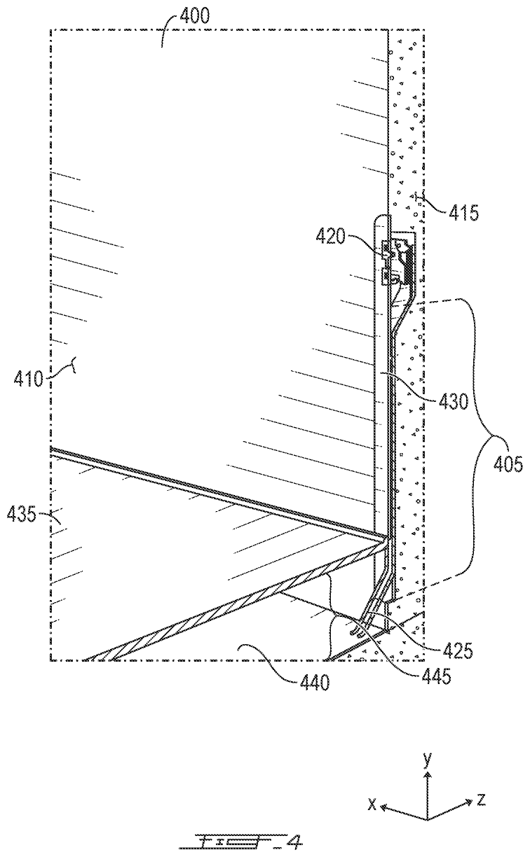

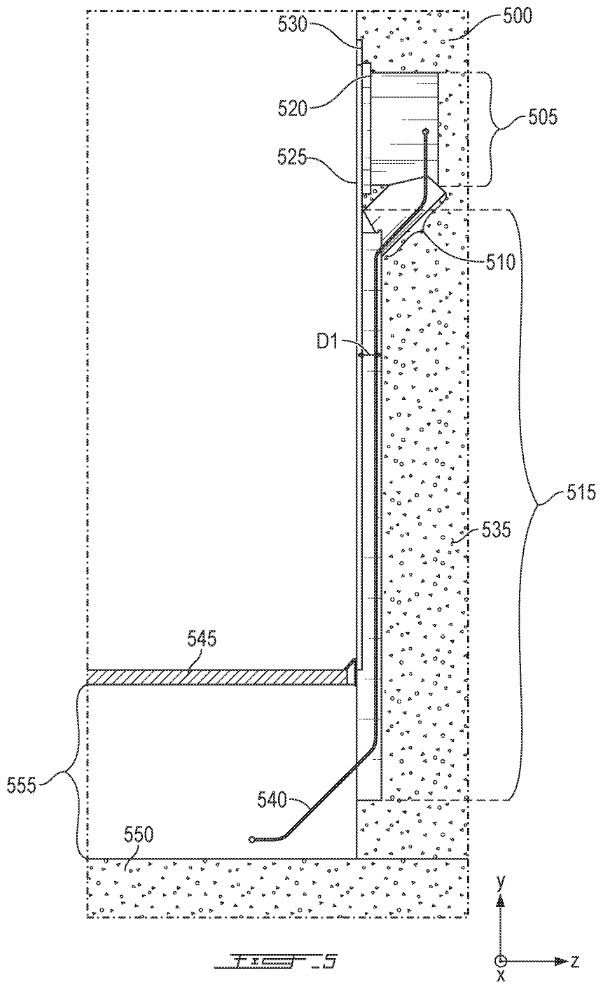

Prefabricated wall 100 and panel surface 140 are examples of, or include aspects of, the corresponding elements described with reference to FIGS. 2-5. First depressed face 105, electrical assembly cavity 110, first electrical pathway 115, and second depressed face 145 are examples of, or includes aspects of, the corresponding elements described with reference to FIGS. 2 and 5. Second electrical pathway 120 and pre-wire assembly 135 are examples of, or include aspects of, the corresponding elements described with reference to FIGS. 2, 4, and 5. Electrical assembly 125 is an example of, or includes aspects of, the corresponding element described with reference to FIGS. 2-4. Tab 130 is an example of, or includes aspects of, the corresponding element described with reference to FIG. 2. Panel interior 150 is an example of, or includes aspects of, the corresponding element described with reference to FIGS. 4 and 5.

According to some aspects, prefabricated wall 100 is formed from a panel. According to some aspects, the panel is a mass timber panel. In some cases, mass timber is an engineered wood product comprising solid wood billet or sheet stock. In some cases, mass timber is beneficial because it is made from a renewable resource and provides an opportunity to act as long-term carbon storage when used in a structure. In some cases, in addition to environmental benefits, the engineered nature of mass timber overcomes many of the issues related to “stick-built” systems. In some cases, each element of a mass timber panel is carefully selected, processed, and oriented to overcome natural variations of lumber products.

According to some aspects, prefabricated wall 100 is formed from a cross-laminated timber (CLT) panel. A CLT panel is an example of a mass timber panel. In some cases, a CLT panel comprises an odd number of laminations of linear wood elements (e.g., layers). In some cases, a thickness of the linear wood elements is in a range from 10 mm (about 0.39 in) to 35 mm (about 1.38 in). In some cases, in each layer of a CLT panel, a grain of wood comprised in a layer of the CLT panel is oriented perpendicular to an adjacent layer of the CLT panel. In some cases, the layers of the CLT panel are glued together, causing the CLT panel to be strong and robust in multiple directions. In some cases, a strength of the CLT panel in one direction may be dominant due to a higher layer count of grain alignment in the odd-numbered layout. In some cases, a CLT panel offers excellent dimensional stability and an ability to be processed with digital fabrication tools to a high tolerance, thereby providing manufacturability flexibility and an increased prefabrication speed.

According to some aspects, prefabricated wall 100 is formed from a glue-laminated timber (GLT), or glulam, panel. A GLT panel is similar to a CLT panel. However, while wood grains of adjacent layers of a CLT panel are orientated in an alternating fashion, wood grains in adjacent layers of a GLT panel are oriented in a same direction. In some cases, a GLT panel includes an even number of layers or an odd number of layers. In some cases, a GLT panel has a greater load capacity due to the alignment of the wood grain orientation among the layers of the GLT panel. In some cases, a GLT panel can be used to optimize load capacity in critical areas such as floor/ceiling spans and wall load capacity, particularly with regards to walls that must meet fire resistance ratings.

According to some aspects, prefabricated wall 100 is formed from a mass plywood panel (MPP). AN MPP is a mass timber panel that can be used in prefabricated housing. Similar to a CLT panel, MPP is composed of layers having an alternating grain orientation. However, an MPP comprises thin layers of wood veneers. An MPP is similar in dimension to a CLT panel and a GLT panel, but is often heavier due to an increased adhesive content.

Referring to FIG. 1, according to some aspects, prefabricated wall 100 includes first depressed face 105, electrical assembly cavity 110, first electrical pathway 115, second electrical pathway 120, and panel surface 140. According to some aspects, first depressed face 105 is depressed or recessed from panel surface 140 (e.g., an outermost face of prefabricated wall 100). In some cases, panel surface 140 extends in a first direction (e.g., a y-direction) and a second direction (e.g., an x-direction) crossing the first direction, and first depressed face 105 is recessed from panel surface 140 in a third direction (e.g., a z-direction) crossing the first direction and the second direction. In some cases, each of the first direction, the second direction, and the third direction are orthagonal to each other.

In some cases, first depressed face 105 is recessed 0.5 inches or less from panel surface 140 in the third direction. In some cases, first depressed face 105 is recessed 0.5 inches or more from panel surface 140 in the third direction. In some cases, first depressed face 105 extends in a parallel direction with panel surface 140. In some cases, first depressed face 105 extends in a direction crossing panel surface 140. In some cases, first depressed face 105 is disposed at any angle relative to panel surface 140. In some cases, panel surface 140 is coextensive with, or comprises, a surface of prefabricated wall 100.

According to some aspects, one or more of electrical assembly cavity 110, first electrical pathway 115, and second electrical pathway 120 are empty spaces extending from a plane which is coplanar with panel surface 140 into panel interior 150 in the third direction. In some cases, panel interior 150 is coextensive with, or comprises, an interior of prefabricated wall 100. In some cases, a portion of electrical assembly cavity 110 intersects with first electrical pathway 115. In some cases, a portion of second electrical pathway 120 intersects with first electrical pathway 115. In some cases, electrical assembly cavity 110 is spaced apart from second electrical pathway 120.

According to some aspects, first electrical pathway 115 consists of a first end, a second end, and a remaining portion. In some cases, the first end opens to electrical assembly cavity 110. In some cases, the second end opens to second electrical pathway 120. In some cases, the remaining portion is surrounded by panel interior 150. For example, in some cases, first electrical pathway 115 is a tunnel between electrical assembly cavity 110 and second electrical pathway 120.

As shown in FIG. 1, at least a portion of each of electrical assembly cavity 110, first electrical pathway 115, and second electrical pathway 120 is open in the third direction (e.g., not covered by a portion of panel surface 140 in the third direction). In some cases, electrical assembly cavity 110 is provided at a first angle. In some cases, first electrical pathway 115 is provided at a second angle different from the first angle. In some cases, second electrical pathway 120 is provided at the first angle. For example, in some cases, electrical assembly cavity 110 and second electrical pathway 120 extend in the first direction, and first electrical pathway 115 extends in a fourth direction crossing the first direction.

In some cases, the fourth direction extends at an angle of from 0 degrees to 90 degrees from the first direction. In some cases, the fourth direction extends at an angle of from about 0 degrees to about 90 degrees from the first direction. In some cases, the fourth direction extends at an angle of 45 degrees from the first direction. In some cases, the fourth direction extends at an angle of about 45 degrees from the first direction.

In some cases, an intersection point of second electrical pathway 120 and first electrical pathway 115 is disposed between panel surface 140 and an intersection point of the first electrical pathway and the electrical assembly cavity.

According to some aspects, electrical assembly 125 is provided on first depressed face 105. In some cases, electrical assembly 125 is at least partially disposed in electrical assembly cavity 110. In some cases, electrical assembly 125 is attached to first depressed face 105 via one or more tabs 130 of electrical assembly 125. In some cases, electrical assembly 125 is attached to first depressed face 105 via a screw, a bolt, a nail, adhesive, or any other appropriate fastener. In some cases, electrical assembly 125 is held in place on first depressed face 105 via a friction fit, allowing for a fast and easy installation of electrical assembly 125. In some cases, first depressed face 105 can act as a directional influence on electrical assembly 125, such that electrical assembly 125 is angled in one or more directions, thereby allowing for easier access behind furniture, cabinetry, appliances, or the like. In some cases, first depressed face 105 provides easier access to electrical assembly 125 for relatively inflexible people.

According to some aspects, electrical assembly 125 comprises an electrical outlet assembly, an electrical switch assembly, or any other electrical assembly. In some cases, electrical assembly cavity 110 houses electrical assembly 125. In some cases, electrical assembly cavity 110 is sized to an aspect ratio similar to an aspect ratio of electrical assembly 125. In some cases, electrical assembly cavity 110 effectively provides a housing for electrical assembly 125, thereby allowing a junction box (e.g., an electrical component enclosure) to be omitted from prefabricated wall 100, accordingly increasing an ease of installation of electrical assembly 125.

According to some aspects, pre-wire assembly 135 (e.g., a wiring loom) or any other wiring or wire assembly is installed in one or more of electrical assembly cavity 110, first electrical pathway 115, and second electrical pathway 120. In some cases, pre-wire assembly 135 is electrically connected to electrical assembly 125. In some cases, pre-wire assembly 135 is electrically connected to electrical assembly 125 via a quick-connect feature.

In some cases, at least a portion of one or more of electrical assembly cavity 110, first electrical pathway 115, and second electrical pathway 120 is open (e.g., uncovered or unobstructed) in the third direction, thereby allowing for easy installation and adjustment of pre-wire assembly 135 (or the other wire or wire assembly). In some cases, one or more of electrical assembly cavity 110, first electrical pathway 115, and second electrical pathway 120 provide a channel that directs a position of pre-wire assembly 135 (or the other wire or wire assembly). In some cases, the quick-connect feature meets a functional or code requirement of an external junction box. Accordingly, prefabricated wall 100 allows for a simpler, cheaper, and faster to installation of electrical assembly 125 and pre-wire assembly 135 than conventional wall systems.

According to some aspects, prefabricated wall 100 includes second depressed face 145. In some cases, second depressed face 145 is disposed between panel surface 140 and first depressed face 105 in the third direction. In some cases, electrical assembly 125 is attached to second depressed face 145 instead of first depressed face 105. In some cases, second depressed face 145 at least partially covers first electrical pathway 115 in the third direction. In some cases, one or more depressed or recessed faces may be included in prefabricated wall 100 to allow multiple components to be located behind, or in line with, panel surface 140. In some cases, a depressed face (such as first depressed face 105 and/or second depressed face 145) may include perpendicular faces that extend in a direction perpendicular to a direction that the depressed face extends in. In some cases, the perpendicular faces may include notches to allow for alignment of an opening of electrical assembly 125. As a result, an installer may not need to align or measure electrical assembly 125 upon installation, and can therefore quickly and easily install electrical assembly 125 with high quality and precision.

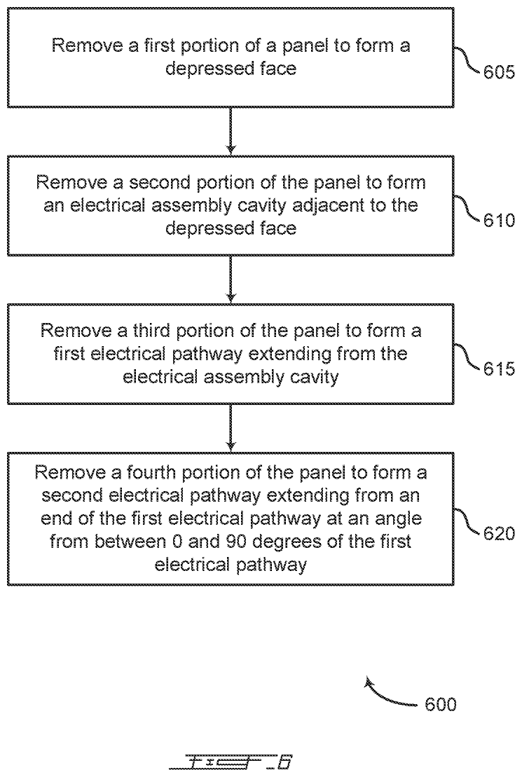

According to some aspects, prefabricated wall 100 is formed as described with reference to FIGS. 6 and/or 7. Additional views of embodiments of prefabricated wall 100 are described with reference to FIGS. 2-5.

FIG. 2 shows an example of a prefabricated wall 200 and a base panel 250 according to aspects of the present disclosure. The example shown includes prefabricated wall 200, first depressed face 205, electrical assembly cavity 210, first electrical pathway 215, second electrical pathway 220, electrical assembly 225, tab 230, pre-wire assembly 235, panel surface 240, second depressed face 245, and base panel 250.

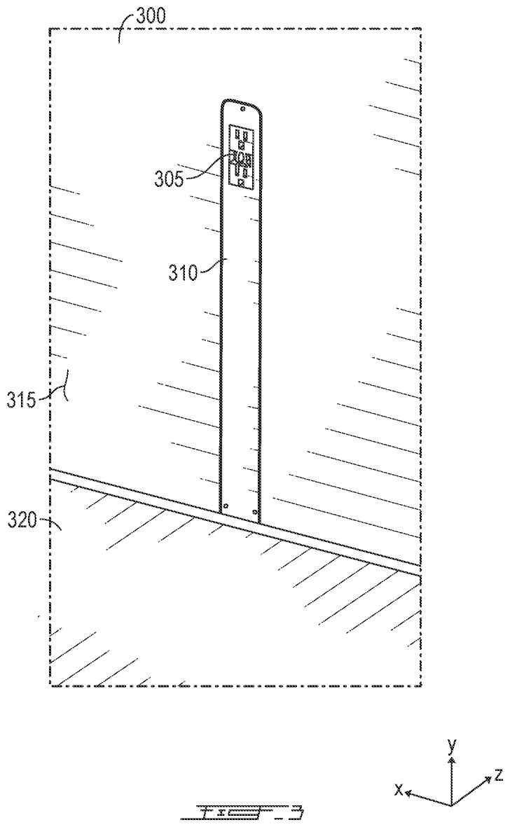

Prefabricated wall 200 and panel surface 240 are examples of, or include aspects of, the corresponding elements described with reference to FIGS. 1 and 3-5. First depressed face 205, electrical assembly cavity 210, first electrical pathway 215, and second depressed face 245 are examples of, or include aspects of, the corresponding elements described with reference to FIGS. 1 and 5. Second electrical pathway 220 and pre-wire assembly 235 are examples of, or include aspects of, the corresponding elements described with reference to FIGS. 1, 4, and 5. Electrical assembly 225 is an example of, or includes aspects of, the corresponding element described with reference to FIGS. 1, 3, and 4. Tab 230 is an example of, or includes aspects of, the corresponding element described with reference to FIG. 1. Base panel 250 is an example of, or includes aspects of, the corresponding element described with reference to FIGS. 3-5.

Referring to FIG. 2, according to some aspects, prefabricated wall 200, including first depressed face 205, electrical assembly cavity 210, first electrical pathway 215, second electrical pathway 220, panel surface 240, and second depressed face 245, is installed adjacent to base panel 250. In some cases, base panel 250 comprises a floor of a building structure. In some cases, prefabricated wall 200 and base panel 250 extend at a right angle, or approximately a right angle, from each other. In some cases, second electrical pathway 220 extends to base panel 250.

As shown in FIG. 2, electrical assembly 225 is installed on first depressed face 205 in electrical assembly cavity 210 and recessed from panel surface 240, pre-wire assembly 235 is installed in electrical assembly cavity 210, first electrical pathway 215, and second electrical pathway 220, and at least a portion of each of electrical assembly cavity 210, first electrical pathway 215, and second electrical pathway 220 is open in the third direction. Electrical assembly 225 may sit at a height away from base panel 250 (for example, to satisfy a building code requirement). However, the present disclosure is not limited thereto, and electrical assembly 225 may be located at any desired height.

FIG. 3 shows an example of a prefabricated wall 300 including a faceplate 310 according to aspects of the present disclosure. The example shown includes prefabricated wall 300, electrical assembly 305, faceplate 310, panel surface 315, and base panel 320.

Prefabricated wall 300 and panel surface 315 are examples of, or include aspects of, the corresponding elements described with reference to FIGS. 1, 2, 4, and 5. Electrical assembly 305 is an example of, or includes aspects of, the corresponding element described with reference to FIGS. 1, 2, and 4. Faceplate 310 is an example of, or includes aspects of, the corresponding element described with reference to FIG. 4. Base panel 320 is an example of, or includes aspects of, the corresponding element described with reference to FIGS. 2, 4, and 5.

Referring to FIG. 3, according to some aspects, prefabricated wall 300 includes faceplate 310 extending to base panel 320. In some cases, faceplate 310 is installed on (e.g., attached to) a second depressed face (such as the second depressed face described with reference to FIG. 2). In some cases, faceplate 310 may have a thickness in the third direction required to meet shallow wire protection code, or any other code (such as building codes within the United States or international building codes). In some cases, faceplate 310 comprises a material including a metal, a semimetal, a polymer, an aramid, any other suitable material, or a combination thereof. In some cases, faceplate 310 is mounted directly to the second depressed face. In some cases, faceplate 310 includes an opening that allows access to the electrical assembly 305. In some cases, at least a portion of faceplate 310 is coplanar to panel surface 315 in the third direction. In some cases, at least a portion of faceplate 310 may be recessed behind or protrude beyond the panel surface 315 in the third direction.

FIG. 4 shows an example of an isometric, cross-sectional view of a prefabricated wall 400 and a base panel 435 according to aspects of the present disclosure. The example shown includes prefabricated wall 400, second electrical pathway 405, panel surface 410, panel interior 415, electrical assembly 420, pre-wire assembly 425, faceplate 430, base panel 435, additional base panel 440, and base opening 445.

Prefabricated wall 400 and panel surface 410 are examples of, or include aspects of, the corresponding elements described with reference to FIGS. 1-3 and 5. Second electrical pathway 405 and pre-wire assembly 425 are examples of, or include aspects of, the corresponding elements described with reference to FIGS. 1, 2, and 5. Panel interior 415 is an example of, or includes aspects of, the corresponding element described with reference to FIGS. 1 and 5. Electrical assembly 420 is an example of, or includes aspects of, the corresponding element described with reference to FIGS. 1-3. Faceplate 430 is an example of, or includes aspects of, the corresponding element described with reference to FIG. 3. Base panel 435 is an example of, or includes aspects of, the corresponding element described with reference to FIGS. 2, 3, and 5. Additional base panel 440 and base opening 445 are examples of, or include aspects of, the corresponding elements described with reference to FIG. 5.

Referring to FIG. 4, according to some aspects, prefabricated wall 400, panel surface 410, and panel interior 415, extends below base panel 435 in the first direction to additional base panel 440. In some cases, additional base panel 440 comprises a sub-floor of a building structure. In some cases, second electrical pathway 405 extends below base panel 435 in the first direction. In some cases, faceplate 430 extends to base panel 435 in the third direction. In some cases, faceplate 430 extends below base panel 435 in the third direction. In some cases, base panel 435 is spaced apart from additional base panel 440 by base opening 445. In some cases, pre-wire assembly 425 is at least partially disposed between base panel 435 and additional base panel 440. In some cases, pre-wire assembly 425 is connected on one end to electrical assembly 420 and on another end to a circuit board.

In some cases, prefabricated wall 400, electrical assembly 420, base panel 435, and additional base panel 440 are disposed within a building (e.g., a building structure). In some cases, base panel 435 prefabricated wall is raised away from additional base panel 440 to provide a channel for mechanical, electrical, and plumbing (MEP) componentry, or other componentry, to pass throughout the building structure.

FIG. 5 shows an example of a side view of a prefabricated wall 500 and a base panel 545 according to aspects of the present disclosure. The example shown includes prefabricated wall 500, electrical assembly cavity 505, first electrical pathway 510, second electrical pathway 515, first depressed face 520, panel surface 525, second depressed face 530, panel interior 535, pre-wire assembly 540, base panel 545, additional base panel 550, and base opening 555.

Prefabricated wall 500 is an example of, or includes aspects of, the corresponding element described with reference to FIGS. 1-4. Electrical assembly cavity 505, first electrical pathway 510, first depressed face 520, and second depressed face 530 are examples of, or include aspects of, the corresponding elements described with reference to FIGS. 1 and 2. Second electrical pathway 515 and pre-wire assembly 540 are examples of, or include aspects of, the corresponding elements described with reference to FIGS. 1, 2, and 4. Panel surface 525 is an example of, or includes aspects of, the corresponding element described with reference to FIGS. 1-4. Panel interior 535 is an example of, or includes aspects of, the corresponding element described with reference to FIGS. 1 and 4. Base panel 545 is an example of, or includes aspects of, the corresponding element described with reference to FIGS. 2-4. Additional base panel 550 and base opening 555 are examples of, or include aspects of, the corresponding elements described with reference to FIG. 4.

Referring to FIG. 5, according to some aspects, a depth D1 of second electrical pathway 515 in the third direction is shallow (e.g., 1.25 inches or less). In some cases, therefore, a distance between a plane which is coplanar with panel surface 525 and a portion of panel interior 535 adjacent to second electrical pathway 515 is 1.25 inches or less. Accordingly, second electrical pathway 515 provides for an easy installation of pre-wire assembly 540, and allows an installation of pre-wire assembly 540 to meet code requirements. Furthermore, by connecting second electrical pathway 515 to electrical assembly cavity 505 via first electrical pathway 510, the depth D1 can be maintained while allowing pre-wire assembly 540 to be connected to an electrical assembly (such as the electrical assembly described with reference to FIGS. 1-4).

As shown in FIG. 5, in some cases, a rear-most surface in the third direction of second electrical pathway 515 is disposed between panel surface 525 and a rear-most surface in the third direction of electrical assembly cavity 505. In some cases, a portion of first electrical pathway 510 is disposed between the rear-most surface in the third direction of second electrical pathway 515 and the rear-most surface in the third direction of electrical assembly cavity 505.

### Forming a Prefabricated Wall

FIG. 6 shows an example of a method 600 for forming a prefabricated wall according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 6, portions of a panel are removed (for example, using a router, a CNC machine, a drill, etc.) to form a prefabricated wall (such as the prefabricated wall described with reference to FIGS. 1-5). In some cases, method 600 describes a stereotomic process, in which material is removed, rather than added (as in a tectonic, or additive, process), to form a structure. A conventional tectonic, “stick-built” method of forming a wall and installing electrical components in the wall includes framing the wall with a bottom plate, a top plate, and studs, running electrical wiring along the studs, attaching drywall to the studs, cutting a hole in the drywall, installing a junction box in the hole, installing an electrical assembly in the junction box, and connecting the electrical wiring to the electrical assembly. This conventional tectonic process is time-consuming and may involve the labor of multiple tradespeople.

By contrast, according to some aspects, method 600 provides a prefabricated wall that promotes an easier installation and maintenance of electrical components than conventional wall-building methods, and allows the use of a junction box to be avoided, thereby minimizing costs.

At operation 605, a first portion of a panel is removed to form a depressed face (such as the first depressed face described with reference to FIGS. 1-2 and 5). In some cases, the panel is a mass timber panel. In some cases, the panel is a CLT panel, a GLT panel, or an MPP.

At operation 610, a second portion of the panel is removed to form an electrical assembly cavity adjacent (such as the electrical assembly cavity described with reference to FIGS. 1, 2 and 5) to the depressed face.

At operation 615, a third portion of the panel is removed to form a first electrical pathway (such as the first electrical pathway described with reference to FIGS. 1, 2, and 5) extending from the electrical assembly cavity.

At operation 620, a fourth portion of the panel is removed to form a second electrical pathway (such as the second electrical pathway described with reference to FIGS. 1, 2, 4, and 5) extending from an end of the first electrical pathway at an angle from between 0 and 90 degrees of the first electrical pathway. In some cases, the second electrical pathway extends to an edge of the panel. In some cases, the second electrical pathway is formed at a depth of 1.25 inches or less from a surface of the panel (such as the panel surface described with reference to FIGS. 1-5). In some cases, a faceplate is provided on the second electrical pathway.

In some cases, the panel extends in a first direction, and at least one of the depressed face, the electrical assembly cavity, and the second electrical pathway extends in the first direction. In some cases, the first electrical pathway is formed at an angle from between 0 and 90 degrees of the first direction. In some cases, the first electrical pathway is formed at an angle of 45 degrees from the first direction. In some cases, the first electrical pathway is formed to open to the electrical assembly cavity, the second electrical pathway, or a combination thereof.

According to some aspects, a fifth portion of the panel is removed to form a second depressed face (such as the second depressed face described with reference to FIGS. 1, 2, and 5) between the surface of the panel and the depressed face.

In some cases, an electrical assembly is installed in the electrical assembly cavity, In some cases, the prefabricated wall omits a junction box. In some cases, the electrical assembly includes a quick connect wire feature. In some cases, the electrical assembly is installed in the electrical assembly cavity via a friction fit. In some cases, the electrical assembly is installed on the depressed face. In some cases, a pre-wire assembly is installed in the panel. In some cases, the pre-wire assembly comprises a wiring loom.

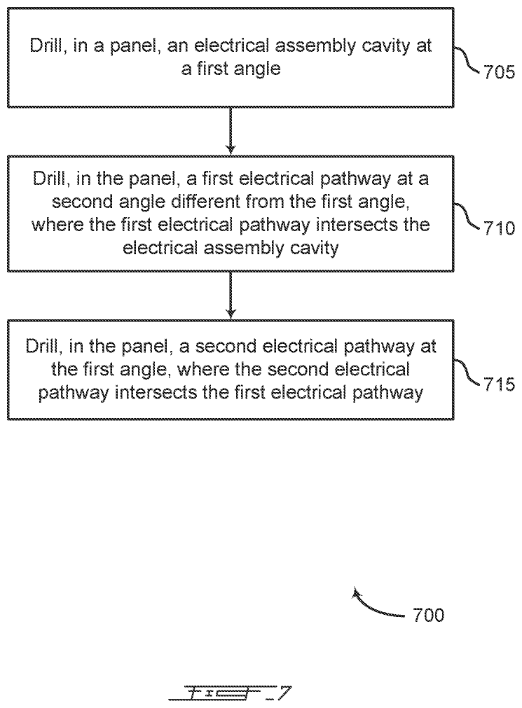

FIG. 7 shows an example of a method 700 for forming a prefabricated wall according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 7, a panel is drilled (for example, using a router, a CNC machine, a drill, etc.) to form a prefabricated wall (such as the prefabricated wall described with reference to FIGS. 1-5). In some cases, method 700 describes a stereotomic process, in which material is removed, rather than added, to form a structure. A conventional tectonic, “stick-built” method of forming a wall and installing electrical components in the wall includes framing the wall with a bottom plate, a top plate, and studs, running electrical wiring along the studs, attaching drywall to the studs, cutting a hole in the drywall, installing a junction box in the hole, installing an electrical assembly in the junction box, and connecting the electrical wiring to the electrical assembly. This conventional tectonic process is time-consuming and may involve the labor of multiple tradespeople.

By contrast, according to some aspects, method 700 provides a prefabricated wall that promotes an easier installation of electrical components than conventional wall-building methods, and allows the use of a junction box to be avoided, thereby minimizing costs.

At operation 705, an electrical assembly cavity (such as the electrical assembly cavity described with reference to FIGS. 1, 2, and 5) is drilled in a panel at a first angle. In some cases, the panel is a mass timber panel. In some cases, the panel is a CLT panel, a GLT panel, or an MPP.

At operation 710, a first electrical pathway (such as the first electrical pathway described with reference to FIGS. 1, 2, and 5) is drilled in the panel at a second angle different from the first angle. In some cases, the first electrical pathway intersects the electrical assembly cavity.

At operation 715, a second electrical pathway (such as the second electrical pathway described with reference to FIGS. 1, 2, 4, and 5) is drilled in the panel at the first angle. In some cases, the second electrical pathway intersects the first electrical pathway.

In some cases, an intersection point of the second electrical pathway and the first electrical pathway is disposed between a surface of the panel (such as the panel surface described with reference to FIGS. 1-5) and an intersection point between the first electrical pathway and the electrical assembly cavity.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for forming a prefabricated wall, comprising:
removing a first portion of a panel to form a depressed face;
removing a second portion of the panel to form an electrical assembly cavity adjacent to the depressed face;
removing a third portion of the panel to form a first electrical pathway extending from the electrical assembly cavity; and
removing a fourth portion of the panel to form a second electrical pathway extending from an end of the first electrical pathway at an angle from between 0 and 90 degrees of the first electrical pathway.

2. The method of claim 1, wherein:
the panel comprises a mass timber panel.

3. The method of claim 2, wherein:
the panel comprises a cross-laminated timber (CLT) panel, a glue-laminated timber (GLT) panel, or a mass plywood panel (MPP).

4. The method of claim 1, wherein:
the panel extends in a first direction; and
at least one of the depressed face, the electrical assembly cavity, and the second electrical pathway extends in the first direction.

5. The method of claim 4, further comprising:
forming the first electrical pathway at an angle from between 0 and 90 degrees of the first direction.

6. The method of claim 5, further comprising:
forming the first electrical pathway at an angle of 45 degrees from the first direction.

7. The method of claim 1, further comprising:
forming the first electrical pathway to open to the electrical assembly cavity, the second electrical pathway, or a combination thereof.

8. The method of claim 1, further comprising:
forming the second electrical pathway at a depth of 1.25 inches or less from a surface of the panel.

9. The method of claim 1, wherein:
the second electrical pathway extends to an edge of the panel.

10. The method of claim 1, further comprising:
installing an electrical assembly in the electrical assembly cavity, wherein the prefabricated wall omits a junction box.

11. The method of claim 10, wherein:
the electrical assembly includes a quick connect wire feature.

12. The method of claim 10, further comprising:
installing the electrical assembly in the electrical assembly cavity via a friction fit.

13. The method of claim 10, further comprising:
installing the electrical assembly on the depressed face.

14. The method of claim 1, further comprising:
removing a fifth portion from the panel to form a second depressed face between a surface of the panel and the depressed face.

15. The method of claim 1, further comprising:
providing a faceplate on the second electrical pathway.

16. The method of claim 1, further comprising:
installing, in the panel, a pre-wire assembly comprising a wiring loom.

17. A method for forming a prefabricated wall, comprising:
drilling, in a panel, an electrical assembly cavity at a first angle;
drilling, in the panel, a first electrical pathway at a second angle different from the first angle, wherein the first electrical pathway intersects the electrical assembly cavity; and
drilling, in the panel, a second electrical pathway at the first angle, wherein the second electrical pathway intersects the first electrical pathway.

18. The method of claim 17, wherein:
an intersection point of the second electrical pathway and the first electrical pathway is disposed between a surface of the prefabricated wall and an intersection point of the first electrical pathway and the electrical assembly cavity.

19. A prefabricated wall, comprising:
a surface;
a depressed face spaced apart from the surface;
an electrical assembly cavity adjacent to the depressed face;
a first electrical pathway extending from the electrical assembly cavity; and
a second electrical pathway extending from an end of the first electrical pathway at an angle from between 0 and 90 degrees of the first electrical pathway.

20. The prefabricated wall of claim 19, wherein:
the first electrical pathway consists of a first end, a second end, and a remaining portion;
the first end opens to the electrical assembly cavity;
the second end opens to the second electrical pathway; and
the remaining portion is surrounded by an interior portion of the prefabricated wall.
